(19) United States
(12) Patent Application Publication
(10) Pub. No.: US 2025/0237912 A1
(43) Pub. Date: Jul. 24, 2025

(54) ELECTRONIC DEVICE

(71) Applicant: InnoLux Corporation, Miao-Li County (TW)

(72) Inventors: Yung-Hsin LU, Miao-Li County (TW); Jian-Min LEU, Miao-Li County (TW); Yu-Shih TSOU, Miao-Li County (TW)

(73) Assignee: InnoLux Corporation, Miao-Li County (TW)

(21) Appl. No.: 19/001,431

(22) Filed: Dec. 25, 2024

(30) Foreign Application Priority Data
Jan. 26, 2024 (CN) 202410109846.2

(51) Int. Cl. G02F 1/1347; G02F 1/1335; G02F 1/137

(52) U.S. Cl. CPC G02F 1/1347; G02F 1/133528; G02F 1/133555; G02F 1/133562; G02F 1/13718

(57) ABSTRACT

Disclosed is an electronic device including a switching unit. The switching unit includes a plurality of pixels, a panel, a phase retardation plate, and a polarizer, wherein the phase retardation plate is disposed between the panel and the polarizer. Each of the pixels has a pattern mode and a transmission mode, wherein at least a part of the pixels in the pattern mode has a first transmittance, and at least another part of the pixels in the transmission mode has a second transmittance, and a difference between the first transmittance and the second transmittance is less than 15%.

### BACKGROUND OF THE DISCLOSURE

### 1. Field of the Disclosure

The present disclosure relates to an electronic device and particularly to an electronic device displaying a pattern and allowing light to pass through.

### 2. Description of the Prior Art

With the development of aesthetic needs for glasses, there have had designs to show various sorts of decorative patterns on the outside of lens. However, as users put on the glasses, the patterns on the lens affect the viewing scenery due to seeing through the lens, which makes the users feel visual discomfort. Therefore, how to minimize discomfort of users as showing patterns on the outside of lens is a problem for the industry to work on.

### SUMMARY OF THE DISCLOSURE

It is an objective of the present disclosure to provide an electrode device to solve issues as mentioned above.

According to some embodiments of the present disclosure, an electronic device is provided and includes a switching unit. The switching unit has a plurality of pixels and comprises a panel, a phase retardation plate, and a polarizer, wherein the phase retardation plate is disposed between the panel and the polarizer. Each of the pixels has a pattern mode and a transmission mode, at least a part of the pixels in the pattern mode has a first transmittance, and another part of the plurality of pixels in the transmission mode has a second transmittance, and a difference between the first transmittance and the second transmittance is less than 15%.

In the electronic device of the present disclosure, the panel with vertical alignment liquid crystal, electrically controlled birefringence liquid crystal, or cholesteric liquid crystal can work with the phase retardation plate and the polarizer to make the pixels in the pattern mode and the pixels in the transmission mode have less than 15% difference in transmittance. Hence, users are hard to see the patterns displayed by the switching unit, lowering the visual discomfort of users.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a side view of an electronic device according to some embodiments of the present disclosure.

FIG. 2 schematically illustrates a cross-section view of a switching unit taken along a line A-A′ in FIG. 1 according to a first embodiment of the present disclosure.

FIG. 3 schematically illustrates a cross-section view of a transflective element according to some embodiments of the present disclosure.

FIG. 4 schematically illustrates a cross-section view of a switching unit according to a second embodiment of the present disclosure.

FIG. 5 schematically illustrates a cross-section view of a switching unit according to a third embodiment of the present disclosure.

FIG. 6 schematically illustrates a cross-section view of a panel according to a third embodiment of the present disclosure.

FIG. 7 schematically illustrates a cross-section view of a switching unit according to a fourth embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected” includes means of direct or indirect electrical connection. Two elements electrically connected to each other may be in direct contact with each other to transfer electrical signals, and there is no other element between them. Alternatively, two elements electrically connected to each other may be bridged through another element between them to transfer electrical signals. The term “electrically connected” may also be referred to as “coupled”.

As disclosed herein, the terms “approximately”, “essentially”, “about”, or “substantially” generally mean within 20%, 10%, 5%, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

An electronic device of the present disclosure may, for example, include a sensing device, a display device, an antenna device, a touch device, a tiled device or other suitable devices, but not limited thereto. The electronic device may, for example, be glasses, a window, or other suitable products. The sensing device may, for example, be a sensing device used for detecting change in capacitances, light, heat, or ultrasound, but not limited thereto. The sensing device may, for example, include a biosensor, a touch sensor, a fingerprint sensor, other suitable sensors or any combination of sensors mentioned above. The display device of the present disclosure may be any kind of display device, such as a self-luminous display device or a non-self-luminous display device. The self-luminous display device may include light emitting diodes, light conversion layers, other suitable materials or any combination of elements mentioned above. The light emitting diode may, for example, include an organic light emitting diode (OLED), a mini light emitting diode (mini LED), a micro light emitting diode (micro LED), a quantum dot light emitting diode (e.g., QLED or QDLED), but not limited thereto. The light conversion layer may include wavelength conversion materials and/or light filtering materials. The light conversion layer may, for example, include a fluorescent material, a phosphor material, quantum dot (QD), other suitable materials or any combination of elements mentioned above, but not limited thereto. The antenna device may, for example, include liquid crystal antenna or antennas of other types, but not limited thereto. The tiled device may, for example, include a tiled display device or a tiled antenna device, but not limited thereto. Furthermore, the appearance of the electronic device may be, for example, rectangular, circular, polygonal, a shape with curved edges, curved or other suitable shapes. The electronic device may have peripheral systems such as a driving system, a control system, a light source system, a shelf system, etc. The electronic device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto.

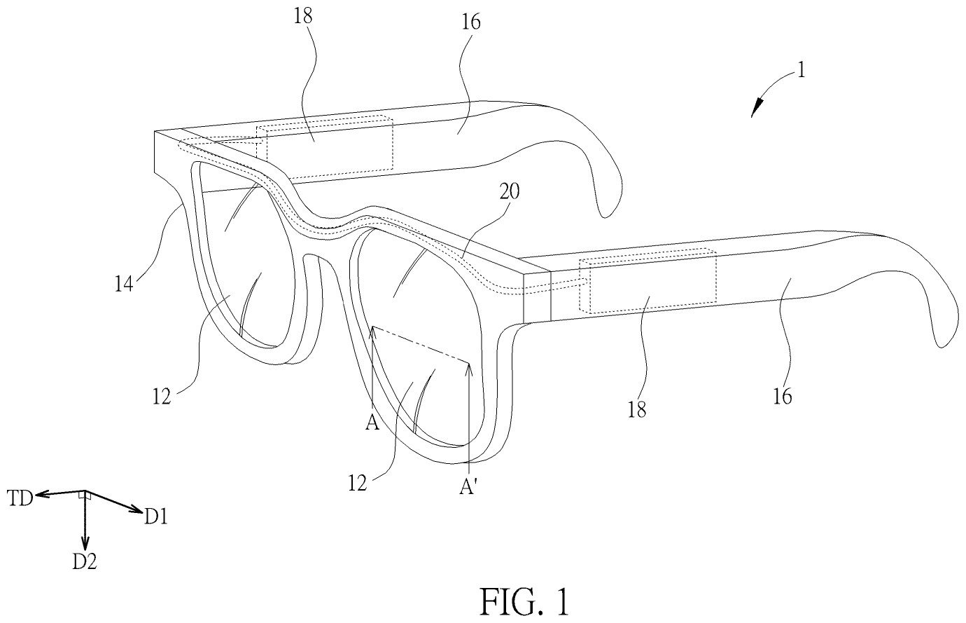

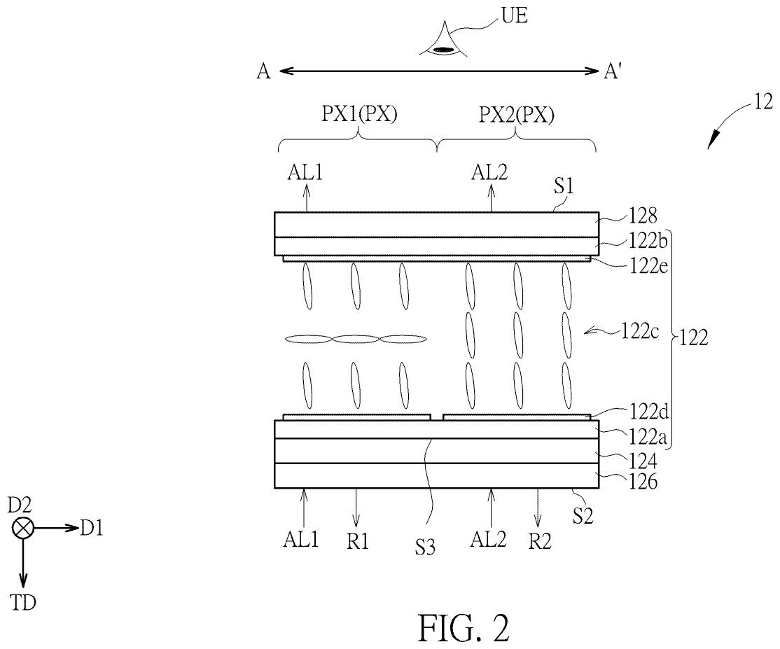

Refer to FIG. 1 and FIG. 2. FIG. 1 schematically illustrates a side view of an electronic device according to some embodiments of the present disclosure. FIG. 2 schematically illustrates a cross-section view of a switching unit taken along a line A-A′ in FIG. 1 according to a first embodiment of the present disclosure. As shown in FIG. 1, an electronic device 1 according to some embodiments may be glasses, and the following electronic device takes glasses for example for clarification in the following contents, but not limited thereto. In other embodiments, the electronic device 1 may be other types of wearable devices or objects, for example, a window, a head-mounted device for augmented reality (AR) or virtual reality (VR), or other suitable objects that allow light to pass through.

As shown in FIG. 1 and FIG. 2, the electronic device 1 may include at least a switching unit 12, and the switching unit 12 includes a plurality of pixels PX. The switching unit 12 may include a panel 122, a phase retardation plate 124, and a polarizer 126, wherein the phase retardation plate 124 is disposed between the panel 122 and the polarizer 126. Besides, each of the pixels PX may have a pattern mode and a transmission mode, at least a part of the pixels PX (e.g., a pixel PX1) has a first transmittance in the pattern mode, and at least another part of the plurality of pixels (e.g., a pixel PX2) has a second transmittance in the transmission mode. A difference between the first transmittance and the second transmittance may be larger than or equal to 0 and smaller than 15%, larger than or equal to 0 and smaller than 108, larger than or equal to 0 and smaller than 5%, or larger than or equal to 0 and smaller than 3%. For example, the difference between the first transmittance and the second transmittance may be larger than or equal to 0 and smaller than 15%, which means 0%≤|(the first transmittance−the second transmittance)|≤15%. In this embodiment, the term “transmittance” refers to a percentage of measured light intensity of ambient light after passing through the pixel divided by measured light intensity of ambient light without passing through the pixel. The configuration mentioned above may reduce or avoid scenery or object viewed by a user UE through the switching unit 12 being affected by a pattern displayed by the switching unit 12. In some embodiments, the pixels PX may be arranged in an array or other suitable arrangements. In the following contents, the part of the pixels PX in the pattern mode takes the pixel PX1 for example, and the part of the pixels PX in the transmission mode takes the pixel PX2 for example for clarification, but not limited thereto.

The switching unit 12 may selectively further include a carrier to carry the panel 122, the phase retardation plate 124, and the polarizer 126. In the embodiment of FIG. 1, as the electronic device 1 is glasses, the carrier of the switching unit 12 may be a lens, wherein the lens may be disposed on a side of the polarizer 126 that is opposite to the phase retardation plate 124 or a side of the panel 122 that is opposite to the phase retardation plate 124 as shown in FIG. 2, but not limited thereto. It is noted that as the switching unit 12 includes the carrier or the lens, the difference between the first transmittance and the second transmittance still complies with the range mentioned above. FIG. 2 neglects the lens to clearly illustrate other elements of the switching unit 12, but not limited thereto. In some embodiments, the switching unit 12 may, for example, be bendable, stretchable, foldable, rollable, or flexible, but not limited thereto.

As shown in FIG. 2, the switching unit 12 may have a first side S1 and a second side S2 opposite to the first side S1, wherein the first side S1 is closer to the user UE (e.g., a user's eye), and the switching unit 12 may display a pattern on the second side S2 as the at least a part of the pixels PX (e.g., the pixel PX1) is in the pattern mode, such that an observer located on the second side S2 of the switching unit 12 is able to see the pattern. In the embodiment of FIG. 2, the panel 122 and the polarizer 126 of the switching unit 12 are close to the first side and the second side, respectively, but not limited thereto. Since the first transmittance of the pixel PX1 in the pattern mode may be close to the second transmittance of the pixels PX2 in transmission mode, the difference between them may be smaller than 15% for example, it may reduce or avoid view of the user UE being affected by the pattern, and for example, the pattern is invisible to the user UE. The term “invisible” in the present disclosure means, for example, during the switch of the pixel between the pattern mode and the transmission mode, the user will not feel this switch, or as the pixel is in the pattern mode, the user is still able to identify external scenery or object without being affected by the pattern even though the user is able to view a faint part of the pattern, but the present disclosure is not limited thereto.

In the embodiment of FIG. 2, the pattern mode of the at least a part of the pixels (e.g., the pixel PX1) and the transmission mode of the at least another part of the pixels (e.g., the pixel PX2) may be performed at the same time. For example, the term “performed at the same time” in the present disclosure may mean as the switching unit 12 displays a pattern, the at least a part of the pixels PX is in the pattern mode while the at least another part of the pixels PX is in the transmission mode, but the pixel PX1 and the pixel PX2 are not limited to be respectively in the pattern mode and the transmission mode in the present disclosure. In some embodiments, each pixel PX may be switched to the pattern mode or the transmission mode depending on needs. For example, as the switching unit 12 needs to display another different pattern to the observer, the switching unit 12 may adjust the modes of the pixels PX based on different patterns, such that the pixel PX1 and the pixel PX2 may be both in the pattern mode or the transmission mode in the same time or respectively be in the transmission mode and the pattern mode.

Specifically, as shown in FIG. 2, the switching unit 12 may selectively further include a transflective element 128, wherein the panel 122 is disposed between the transflective element 128 and the phase retardation plate 124, so that the transflective element 128 is closer to the user UE than the panel 122. The transflective element 128 may be used to reflect a part of light emitted to the transflective element 128 and allow another part of light emitted to the transflective element 128 to pass through. In the embodiment of FIG. 2, the transflective element 128 may, for example, include a metal film or other suitable elements. Under this circumstance, the metal film may not have a pattern, and the metal film may cover an entire surface of the panel 122 facing the transflective element 128, but not limited thereto. The metal film may, for example, include silver, aluminum, other suitable materials, or any combination of materials mentioned above. The metal film may, for example, be a multilayer and may be formed on a surface of the panel 122 by electroplating, but not limited thereto. In this embodiment, a transmittance and a reflectance of the transflective element 128 are trade-off, which may be controlled by adjusting a thickness of the metal film or other conditions. A ratio of the transmittance to the reflectance of the transflective element 128 may, for example, be 50%:50%, 80%:20%, or other ratio.

In the embodiment of FIG. 2, the panel 122 may, for example, include vertical alignment (VA) liquid crystal, so that a part of the panel 122 corresponding to the pixel PX1 in the pattern mode has a function of phase retardation while another part of the panel 122 corresponding to the pixel PX2 in the transmission mode does not have the function of phase retardation.

For example, the panel 122 may include a first substrate 122a, a second substrate 122b, a liquid crystal layer 122c, a plurality of first electrodes 122d, and a plurality of second electrodes 122e, wherein the first substrate 122a and the second substrate 122b are disposed opposite to each other, the liquid crystal layer 122c is disposed between the first substrate 122a and the second substrate 122b, the first electrodes 122d are disposed between the first substrate 122a and the liquid crystal layer 122c, and the second electrodes 122e are disposed between the second substrate 122b and the liquid crystal layer 122c. Orientations of liquid crystal molecules in the liquid crystal layer 122c may be adjusted by controlling a voltage difference between the first electrode 122d and the second electrode 122e of each pixel PX to switch the pattern mode and the transmission mode of each pixel PX.

The first substrate 122a and the second substrate 122b may include hard or flexible transparent substrate material, and for example, include glass, ceramic, quartz, sapphire, polyimide (PI), polyethylene terephthalate (PET), polycarbonate (PC), polyethersulfone (PES), polybutylene terephthalate (PBT), polyethylene naphthalate (PEN), polyarylate (PAR), other suitable materials, or any combination of materials mentioned above, but not limited thereto. The first electrodes 122d and the second electrodes 122e may include transparent conductive materials, for example, indium tin oxide or other suitable materials.

In FIG. 2, since the liquid crystal molecules in the liquid crystal layer 122c are VA liquid crystal, as the voltage difference between the first electrode 122d and the second electrode 122e is zero, long axes of the liquid crystal molecules may substantially be perpendicular to a surface S3 of the panel 122 facing the phase retardation plate 124, so that the pixel PX2 corresponding to the voltage difference of zero may be in the transmission mode. As the voltage difference between the first electrode 122d and the second electrode 122e is not zero, the long axes of the liquid crystal molecules may not be perpendicular to the surface S3 of the panel 122 facing the phase retardation plate 124, so that the liquid crystal molecules have a phase retardation effect on light. Accordingly, the pixel PX1 corresponding to the voltage difference of non-zero may be in the pattern mode.

In some embodiments, the first electrodes 122d and the second electrodes 122e may, for example, be strip-shaped, wherein the first electrodes 122d are arranged in a first direction D1 and the second electrodes 122e are arranged in a second direction D2 perpendicular to the first direction D1, so that overlapping parts of the first electrode 122d and the second electrode 122e may be used to control the mode of the corresponding pixel PX in a top view direction TD of the switching unit 12. Alternatively, the second electrode 122e may be a single electrode overlapped with all the pixels PX, and each of the first electrodes 122d may individually correspond to one of the pixels PX. Under this circumstance, the first substrate 122a may include a circuit layer (not shown). For example, the circuit layer may include a thin-film transistor or other suitable active elements used to control a voltage of one of the first electrodes 122d to change the voltage difference between the first electrode 122d and the second electrode 122e, but not limited thereto. In some embodiments, positions of the first electrode 122d and the second electrode 122e may be interchanged.

In some embodiments, the panel 122 may, for example, include two alignment layers disposed between the first electrodes 122d and the liquid crystal layer 122c and disposed between the second electrode 122e and the liquid crystal layer 122c, respectively.

In the embodiment of FIG. 2, the polarizer 126 may be a linear polarizer, which includes a transmission axis and allows a linear polarized light whose linear polarization direction is parallel to the transmission axis to pass through. The phase retardation plate 124 may, for example, be a quarter wavelength phase retardation plate and have a fast axis and a slow axis, wherein the fast axis is perpendicular to the slow axis. In an embodiment, as viewed in the top view direction TD of the switching unit 12, an angle between the transmission axis of the polarizer 126 and the slow axis or the fast axis of the phase retardation plate 124 may, for example, be substantially 45 degrees. For example, the phase retardation plate 124 has a phase retardation characteristic of an A plate, that is to say nx of the phase retardation plate 124 is not equal to ny of the phase retardation plate 124, where nx and ny may be refraction indices in two in-plane directions of the phase retardation plate 124, respectively, and the two in-plane directions are perpendicular to each other. A value of phase retardation ((nx−ny)×d) may, for example, be in a range of 100 nm to 150 nm or substantially 140 nm, wherein d is a thickness of the phase retardation plate 124 in a thickness direction perpendicular to the two in-plane directions. The thickness direction may, for example, be parallel to the top view direction TD of the switching unit 12.

In FIG. 2, an ambient light AL1 and an ambient light AL2 respectively enter the polarizer 126 of the pixel PX1 and the pixel PX2 from the second side S2 and are turned into linear polarized light after passing through the polarizer 126, and then, the linear polarized light enters the phase retardation plate 124. The linear polarized light is turned into circular polarized light after passing through the phase retardation plate 124 and then enters the panel 122.

As the pixel PX1 is in the pattern mode, a corresponding part of the panel 122 to the pixel PX1 has a function of phase retardation. Therefore, the circular polarized light entering the corresponding part of the panel 122 is retarded in phase after passing through the corresponding part of panel 122 and then becomes a polarized light (e.g., elliptical polarized light), which has a phase difference with the circular polarized light. A part of the polarized light may pass through the transflective element 128. Hence, a part of the ambient light AL1 emitted to the pixel PX1 may pass through the switching unit 12 and then be seen by the user UE. Besides, another part of the polarized light is reflected by the transflective element 128 and then becomes a nonlinear polarized light or a linear polarized light whose linear polarization direction is parallel to the transmission axis of the polarizer 126 after passing through the phase retardation plate 124. Therefore, the nonlinear polarized light or the linear polarized light may pass through the polarizer 126, such that the observer on the second side S2 of the switching unit 12 may see reflection light R1 emitted from the second side S2 of the pixel PX1.

As the pixel PX2 is in the transmission mode, a corresponding part of the panel 122 to the pixel PX2 does not have the function of phase retardation. Therefore, the circular polarized light emitted to the corresponding part of the panel 122 may pass through the panel 122 and be emitted to the transflective element 128. Besides, the transflective element 128 may allow a part of the circular polarized light to pass through. Hence, a part of the ambient light AL2 emitted to the pixel PX2 may pass through the switching unit 12 and then be seen by the user UE. The transflective element 128 may further reflect another part of the circular polarized light, which becomes another linear polarized light after passing through the phase retardation plate 124. Since linear polarization direction of the another linear polarized light is substantially perpendicular to the transmission axis of the polarizer 126, the another linear polarized light may not pass through the polarizer 126, or majority of the another linear polarized light may be absorbed by the polarizer 126, such that the observer on the second side S2 of the switching unit 12 may not see reflection light R2 emitted from the second side S2 of the pixel PX2 or see the faint reflection light R2.

It is noted that since the ambient light AL1 emitted to the pixel PX1 and the ambient light AL2 emitted to the pixel PX2 both pass through the polarizer 126, the panel 122, and the transflective element 128, the part of the ambient light AL1 after passing through the pixel PX1 and the part of the ambient light AL2 after passing through the pixel PX2 may have an identical or similar intensity. Besides, a transmission spectrum of the pixel PX1 in the pattern mode may be close or identical to a transmission spectrum of the pixel PX2 in the transmission mode. Therefore, outlines and colors of scenery or objects viewed by the user UE may not be affected by the pattern displayed by the pixel PX1, that is, without being affected by switching between the pattern mode and transmission mode of the pixel PX. In this way, as the observer on the second side S2 of the switching unit 12 sees the pattern, the user UE is not easily to see the pattern displayed on the second side S2, which lowers or avoids the visual discomfort of the user UE.

Besides, as the ambient light AL1 emitted to the pixel PX1 and the ambient light AL2 emitted to the pixel PX2 have identical or similar intensity, an intensity of the reflection light R1 corresponding to the pixel PX1 may be larger than an intensity of the reflection light R2 corresponding to the pixel PX2. That is to say, the reflectance of a part of the second side S2 of the switching unit 12 corresponding to the pixel PX1 in the pattern mode may be larger than the reflectance of another part of the second side S2 of the switching unit 12 corresponding to the pixel PX2 in the transmission mode, such that the observer may see the pattern with high contrast ratio.

In the embodiment of: FIG. 2, the reflectance and the transmittance of the switching unit 12 may be adjusted according to the ratio of the transmittance to the reflectance of the transflective element 128. For example, the transmittance of the switching unit 12 may be in the range of 1% to 40% while the reflectance of the switching unit 12 may be in the range of 1% to 40%.

It is worth noted that the liquid crystal molecules in different orientations have different reflectances to different wavelengths of light. Therefore, as the voltage difference between the first electrode 122d and the second electrode 122e of the pixel PX1 is changed, a color of the reflection light R1 may change, such that the pattern displayed by the pixel PX1 may be a color pattern. For example, under the condition that the ratio of the transmittance to the reflectance of the transflective element 128 is 50%:50%, as the voltage difference between the first electrode 122d and the second electrode 122e is 3V, 3.8V, and 6V, the switching unit 12 will respectively show blue, green, and red light whose reflectance will be 2.6%, 13.8%, and 11.1% respectively. Therefore, by adjusting the voltage difference between the first electrode 122d and the second electrode 122e, the pixel PX1 may display the color pattern.

In some embodiments, the phase retardation plate 124 may be replaced by another phase retardation plate and a half-wave plate, wherein the half-wave plate may be disposed between the polarizer 126 and the another phase retardation plate. Under this circumstance, the angle between a slow axis (or a fast axis) of the another phase retardation plate and the transmission axis of the polarizer 126 may, for example, be 75 degrees, and the angle between a slow axis (or a fast axis) of the half-wave plate and the transmission axis of the polarizer 126 may, for example, be 15 degrees. Compared with the single phase retardation plate 124, a combination of the another phase retardation plate and the half-wave plate may broaden a wavelength band of phase retarded light. A value of in-plane phase retardation of the another phase retardation plate may, for example, be in a range of 100 nm to 150 nm or substantially 140 nm, and a value of in-plane phase retardation of the half-wave plate may, for example, be in a range of 240 nm to 280 nm or substantially 270 nm.

In some embodiments, according to different design requirements, the switching unit 12 may selectively not include the phase retardation plate 124, such that the reflectance of the part of the second side S2 of the switching unit 12 corresponding to the pixel PX1 in the pattern mode may not be larger than the reflectance of another part of the second side S2 of the switching unit 12 corresponding to the pixel PX2 in the transmission mode, but not limited thereto.

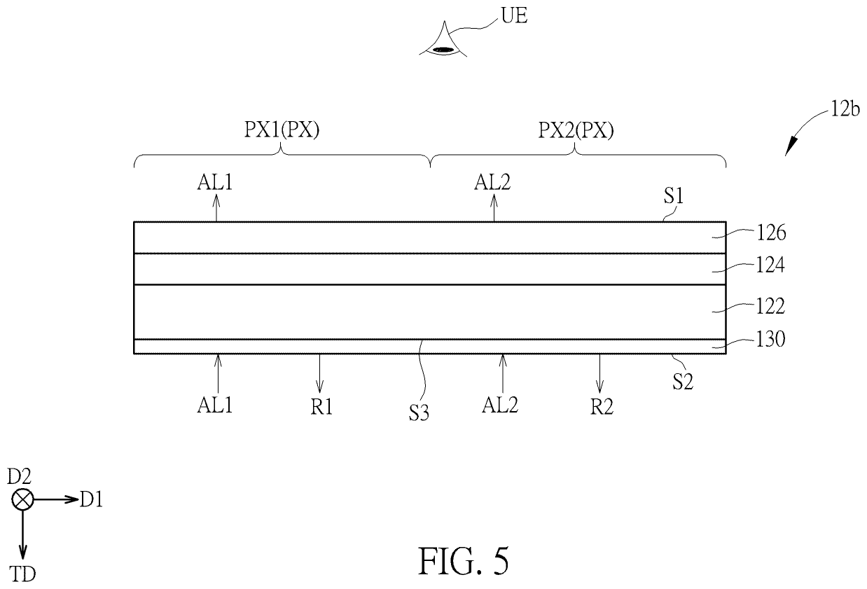

In some embodiments, the switching unit 12 may further include an anti-reflection film (e.g., the anti-reflection film 130 illustrated in FIG. 5) disposed on a surface of the phase retardation plate 124 opposite to the polarizer 126.

Refer to FIG. 1. In the embodiment of FIG. 1, the electronic device 1 may further include a frame 14 and two temples 16, and the electronic device 1 may include two switching units 12, but not limited thereto. Each of the switching units 12 may be disposed in a corresponding opening or inner side of the frame 14. The temples 16 may be connected to two sides of the frame 14 respectively. In some embodiments, the electronic device 1 may, for example, further include a driving element 18 disposed inside the temple 16. The driving element 18 may be used to control switch, mode switching, or other functions of the switching unit 12. Under this circumstance, the electronic device 1 may further include a wire 20 extending from the temple 16 to the frame 14 and used to electrically connect the switching unit 12 to the driving element 18, but not limited thereto. In some embodiments, the driving element 18 may, for example, include buttons or other suitable elements, or be replaced by a battery or other suitable elements.

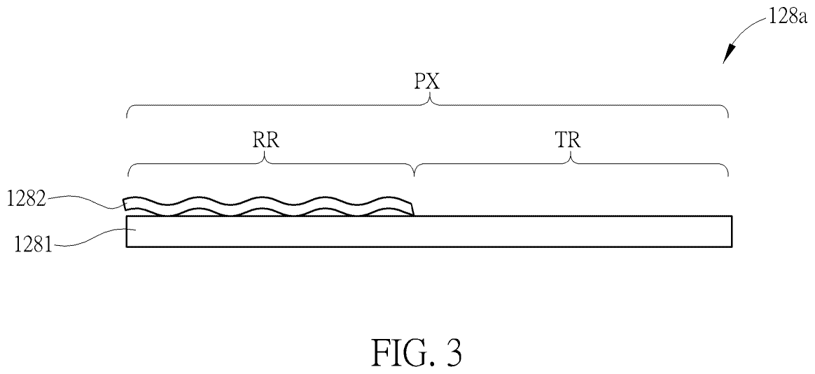

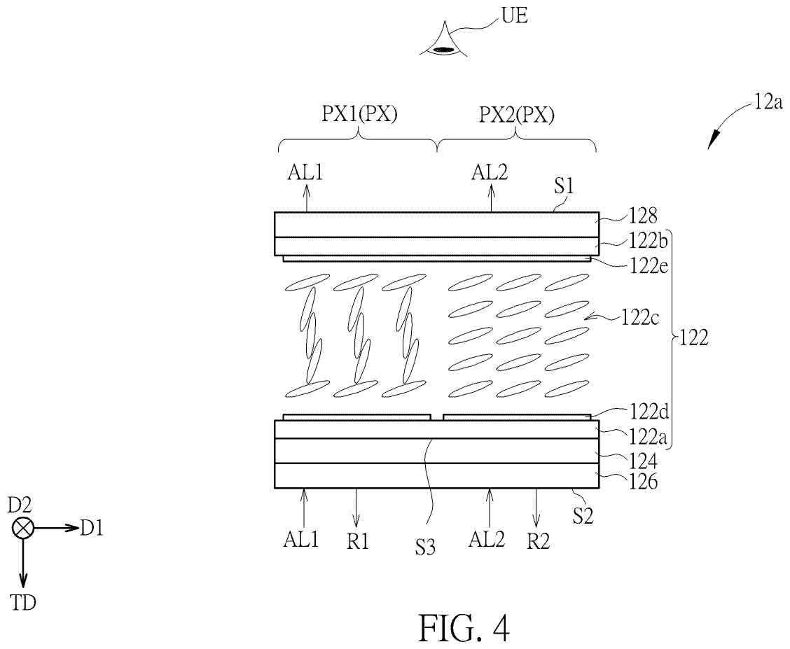

Refer to FIG. 3. FIG. 3 schematically illustrates a cross-section view of a transflective element according to some embodiments of the present disclosure. As shown in FIG. 3, in some embodiments, a part of the transflective element 128a corresponding to the pixel PX may include a transmission region TR and a reflection region RR. FIG. 3 takes single pixel PX for example, but not limited thereto. For example, the transflective element 128a may include a transparent film 1281 and a reflection layer 1282, wherein the reflection layer 1282 is disposed on the transparent film 1281 in the reflection region RR and used to reflect light. The reflection layer 1282 is not disposed on the transparent film 1281 in the transmission region TR, such that the transmission region TR of the transflective element 128a may allow light to pass through. By adjusting a ratio of an area of the reflection region RR to an area of the transmission region TR, the reflectance and the transmittance of the transflective element 128a may be controlled. In some embodiments, the reflection layer 1282 may, for example, include metal film and may, for example, include silver, aluminum, other suitable materials, or any combination of materials mentioned above. Metal film may, for example, be a multilayered film. In some embodiments, the reflection layer 1282 may have an uneven upper surface used to scatter light to reduce mirror reflection. For example, a plurality of protrusions may be disposed on the transparent film 1281, wherein the reflection layer 1282 is formed on the protrusions, such that the reflection layer 1282 has the uneven upper surface, but the present disclosure is not limited thereto. In some embodiments, the transflective element 128a in FIG. 3 may replace the transflective element 128 in FIG. 2 or FIG. 4, but not limited thereto.

The electronic device is not limited to the above mentioned embodiments and may have other embodiments. To simplify description, other embodiments in the following contents will use the same notations to the same elements from the above mentioned embodiments. To clearly clarify other embodiments, the following contents will emphasize on the difference between other embodiments and the above mentioned embodiments, and will not further elaborate for the repeated part.

Refer to FIG. 4. FIG. 4 schematically illustrates a cross-section view of a switching unit according to a second embodiment of the present disclosure. As shown in FIG. 4, the difference between a switching unit 12a of this embodiment and the switching unit 12 in FIG. 2 is the panel 122 of this embodiment may include electrically controlled birefringence (ECB) type liquid crystal. In the embodiment of FIG. 4, since the liquid crystal molecules in the liquid crystal layer 122c are ECB type liquid crystal, as the voltage difference between the first electrode 122d and the second electrode 122e corresponding to a pixel (e.g., pixel PX1) is not zero, the orientations of the liquid crystal molecules may be driven to turn, such that the long axes of the liquid crystal molecules are not parallel to the surface S3. Under this circumstance, the corresponding part of the panel 122 to the pixel PX1 has the function of phase retardation, such that the corresponding pixel PX1 may be in the pattern mode. As the voltage difference between the first electrode 122d and the second electrode 122e corresponding to another pixel PX (e.g., pixel PX2) is zero, the orientations of the liquid crystal molecules between the first electrode 122d and the second electrode 122e are homogeneous alignment, which is the long axes of the liquid crystal molecules are substantially parallel to the surface S3. In this case, the corresponding part of the panel 122 to the pixel PX2 does not have the function of phase retardation, such that the corresponding pixel PX2 may be in the transmission mode. Since other parts of the switching unit 12a may be the same as the switching unit 12 in FIG. 2, please refer to the above contents, and no further elaboration will be mentioned herein.

It is noted that in the embodiment of FIG. 4, as the voltage difference between the first electrode 122d and the second electrode 122e of each pixel PX1 alters, the color of the reflection light R1 also changes, such that the pixel PX1 may display the color pattern. For example, as the voltage difference between the first electrode 122d and the second electrode 122e is 5.2V, 1.8V, and 1V, the switching unit 12a will respectively show blue, green, and red light whose reflectance will be 1.4%, 15.3%, and 4.7% respectively. Therefore, by adjusting the voltage differences between the first electrodes 122d and the second electrodes 122e, the pixel PX1 may display the color pattern. Besides, as the voltage difference between the first electrode 122d and the second electrode 122e gradually increases, the color displayed by the pixel PX1 changes sequentially from purple, red, green, and then to blue.

In some embodiments, the switching unit 12a may selectively not include the phase retardation plate 124. Under this circumstance, as the voltage difference between the first electrode 122d and the second electrode 122e gradually increases, the color displayed by the pixel PX1 changes sequentially from green, blue, purple, and then to red.

In some embodiments, the switching unit 12a may further include an anti-reflection film (e.g., the anti-reflection film 130 illustrated in FIG. 5) disposed on a surface of the phase retardation plate 124 opposite to the polarizer 126.

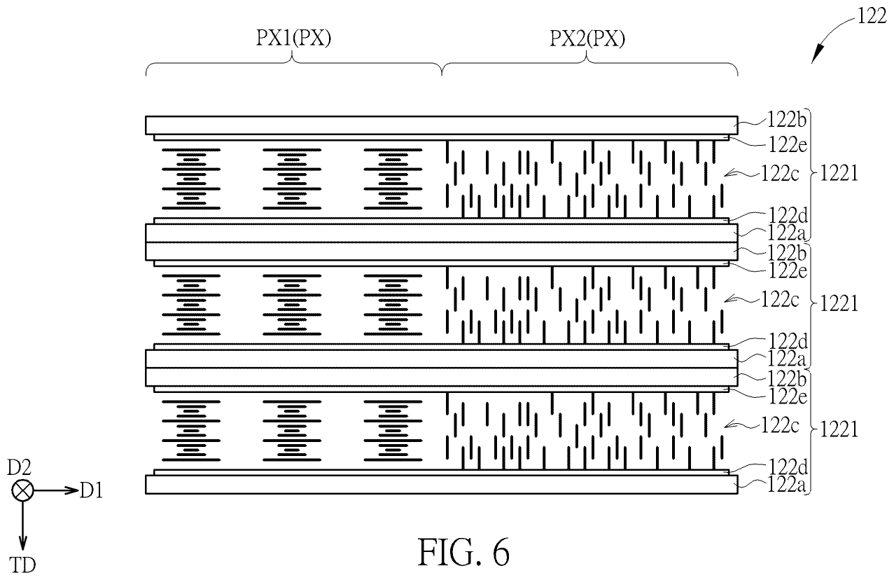

Refer to FIG. 5 and FIG. 6. FIG. 5 schematically illustrates a cross-section view of a switching unit according to a third embodiment of the present disclosure, and FIG. 6 schematically illustrates a cross-section view of a panel according to a third embodiment of the present disclosure. As shown in FIG. 5, the difference between the switching unit 12b in this embodiment and the switching unit 12 in FIG. 2 is that the panel 122 in this embodiment may include cholesteric liquid crystal, wherein the cholesteric liquid crystal in the pattern mode may be in a planar state while the cholesteric liquid crystal in the transmission mode may be in a homeotropic state or a focal-conic state. In this embodiment, the polarizer 126 of the switching unit 12b may be closer to the first side S1 than the panel 122, which means the polarizer 126 is closer to the user UE. The panel 122 is closer to the second side S2 than the polarizer 126. That is, a surface of the panel 122 opposite to the phase retardation plate 124 may display a pattern as at least a part of the pixels PX (e.g., pixel PX1) is in the pattern mode.

In the embodiment of FIG. 5, for the ambient light AL1 is unpolarized light, the ambient light AL1 may be separated into right-hand circular (RHC) polarized light and left-hand circular (LHC) polarized light. Since the cholesteric liquid crystal in the planar state may reflect a certain wavelength band of the right-hand circular polarized light (or left-hand circular polarized light) of the ambient light AL1 and allow the left-hand circular polarized light (or right-hand circular polarized light) to pass through, as the ambient light AL1 is emitted to the part of the panel 122 corresponding to the pixel PX1 in the pattern mode, the cholesteric liquid crystal may reflect half of the ambient light AL1 to become the reflection light R1 and allow the other half of the ambient light AL1 to pass through. A rotation direction of a reflected circular polarized light may be determined by a chiral structure of the cholesteric liquid crystal. The circular polarized light after passing through the panel 122 may be emitted to the phase retardation plate 124 and then be retarded in phase to become a linear polarized light after passing through the phase retardation plate 124. By disposing the transmission axis of the polarizer 126 to be parallel to the polarization direction of the linear polarized light, majority of the linear polarized light passing through the panel 122 may be allowed to pass through the polarizer 126, such that a part of the ambient light AL1 may pass through the pixel PX1 and be seen by the user UE.

Besides, since the cholesteric liquid crystal in the homeotropic state may allow the ambient light AL2 to pass through, as the ambient light AL2 is emitted to the part of the panel 122 corresponding to the pixel PX2 in the transmission mode, majority of the ambient light AL2 may pass through the panel 122 and be emitted to the phase retardation plate 124. Since the ambient light AL2 passing through the panel 122 is unpolarized light, the ambient light AL2 may pass through the phase retardation plate 124 and be emitted to the polarizer 126. Besides, since the polarizer 126 is a linear polarizer, half of the ambient light AL2, which has a linear polarization direction parallel to the transmission axis of the polarizer 126, may pass through the polarizer 126 while the other half is absorbed by the polarizer 126, such that the observer on the second side S2 may not see the reflection light R2 emitted from the second side S2 of the pixel PX2 or see the faint reflection light R2.

It is noted that a part of the ambient light AL1 passing through the pixel PX1 and a part of the ambient light AL2 passing through the pixel PX2 may have identical or similar intensity, and a transmission spectrum of the pixel PX1 in the pattern mode may be close or identical to a transmission spectrum of the pixel PX2 in transmission mode. Therefore, outlines and colors of scenery or objects viewed by the user UE may not be affected by the pattern displayed by the pixel PX1. That is, the pattern is invisible to the user UE. Besides, the half of the ambient light AL1 emitted to the pixel PX1 may become the reflection light R1, and the ambient light AL2 emitted to the pixel PX2 may be absorbed or pass through the polarizer 126. Therefore, a reflectance of a part of the second side S2 of the switching unit 12b corresponding to the pixel PX1 in the pattern mode may be larger than a reflectance of another part of the second side S2 of the switching unit 12b corresponding to the pixel PX2 in the transmission mode, such that the observer may see the pattern with higher contrast ratio.

Besides, color of light reflected by the cholesteric liquid crystal in the planar state is related to a pitch of the cholesteric liquid crystal. Therefore, a single layer of the cholesteric liquid crystal may just reflect light with a single color. In the embodiment of FIG. 6, in order to display the color pattern, the panel 122 may include a plurality of subpanels 1221 stacked in the top view direction TD. Each of the subpanels 1221 may include a first substrate 122a, a second substrate 122b, a liquid crystal layer 122c, a plurality of first electrodes 122d, and a plurality of second electrodes 122e. It is noted that by providing different voltage differences between the first electrodes 122d and the second electrodes 122e of parts of different subpanels 1221 corresponding to the pixel PX1, the cholesteric liquid crystals of different liquid crystal layers 122c may have different pitches, which may reflect different wavelength bands of the ambient light AL1 to display the color pattern. For example, the liquid crystal layers 122c of parts of the subpanels 1221 corresponding to the pixel PX1 may respectively reflect red, green, and blue light, but not limited thereto. In an embodiment, different subpanels 1221 may be attached to each other by adhesive layers, but not limited thereto. Structures of the first substrate 122a, the second substrate 122b, the first electrodes 122d, and the second electrodes 122e may be similar or identical to the structures in the FIG. 2, and hence, here will be no further elaboration. In some embodiments, the panel 122 may be single subpanel 1221, such that the switching unit 12b displays a monochrome pattern.

In FIG. 6, as the pixel PX2 is in the transmission mode, the liquid crystal layers 122c of parts of different subpanels 1221 corresponding to the pixel PX2 may respectively be in the homeotropic state, but not limited thereto. In some embodiments, as the pixel PX2 is in the transmission mode, at least one of the liquid crystal layers 122c of parts of different subpanels 1221 corresponding to the pixel PX2 may be in the focal-conic state. Since the focal-conic state is one of two stable states of the cholesteric liquid crystal, power consumption may be reduced under this circumstance.

In the embodiment of FIG. 5 and FIG. 6, the transmittance of the switching unit 12b may, for example, be in the range of 30% to 50%, and the reflectance of the switching unit 12b may be in the range of 20% to 50%, but not limited thereto. Since other structures of the switching unit 12b of this embodiment may be identical to the switching unit 12 in FIG. 2, please refer to the above contents, and no further elaboration will be mentioned herein.

In some embodiments, as shown in FIG. 5, the switching unit 12b may further include an anti-reflection film 130 used to reduce the intensities of the reflection light R1 and the reflection light R2, wherein the panel 122 is disposed between the phase retardation plate 124 and the anti-reflection film 130. In the case that the panel 122 may include the cholesteric liquid crystal, the anti-reflection film 130 may be disposed on the surface of the panel 122 opposite to the phase retardation plate 124, but not limited thereto. The anti-reflection film 130 in FIG. 5 may be applied to the switching unit 12 in FIG. 2 or the switching unit 12a in FIG. 4. In some embodiments, the phase retardation plate 124 may be replaced by the another phase retardation plate and the half-wave plate mentioned above, but not limited thereto.

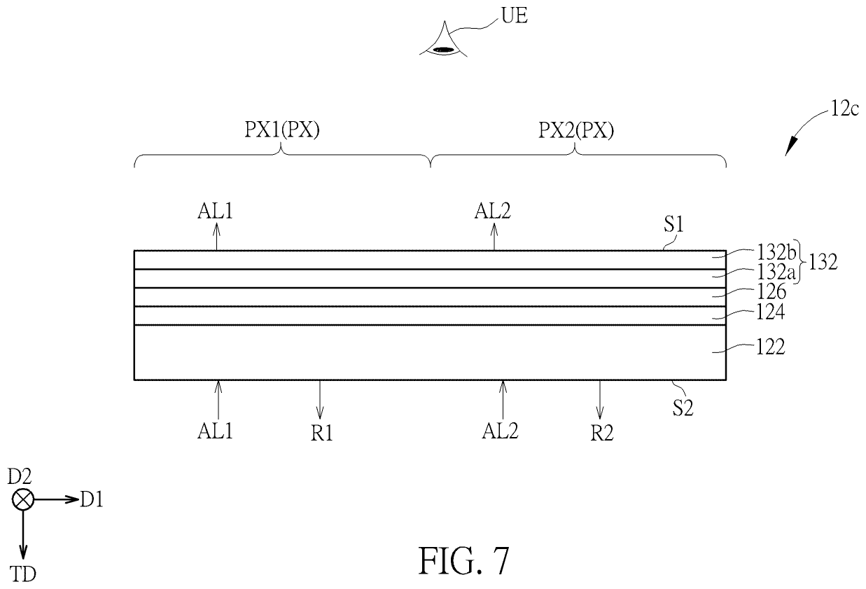

Refer to FIG. 7. FIG. 7 schematically illustrates cross-section view of a switching unit according to a fourth embodiment of the present disclosure. As shown in FIG. 7, the difference between the switching unit 12c of this embodiment and the switching unit 12b in FIG. 5 is that the switching unit 12c may further include a light-adjusting element 132, wherein the polarizer 126 is disposed between the phase retardation plate 124 and the light-adjusting element 132, and the light-adjusting element 132 may be used to adjusting an intensity of light passing through itself. In this embodiment, the light-adjusting element 132 may, for example, include a liquid crystal panel 132a and a polarizer 132b, wherein the liquid crystal panel 132a may be disposed between the polarizer 126 and the polarizer 132b. For example, the liquid crystal panel 132a may include vertical alignment liquid crystal, and a transmission axis of the polarizer 132b may be parallel to the transmission axis of the polarizer 126, such that the ambient light AL1 and the ambient light AL2 both passing through the polarizer 126 may pass through the liquid crystal panel 132a and the polarizer 132b when the liquid crystal panel 132a is not driven. Besides, by adjusting a voltage difference used for driving the liquid crystal molecules of the liquid crystal panel 132a, a transmittance of the light-adjusting element 132 may be controlled to adjust the intensities of the ambient light AL1 and the ambient light AL2 perceived by the user UE. In some embodiments, the liquid crystal panel 132a may, for example, include an upper electrode, a liquid crystal layer, and a lower electrode, wherein the liquid crystal layer is disposed between the upper electrode and the lower electrode, and the upper electrode and the lower electrode may not be patterned and cover an entire surface of the polarizer 126 opposite to the light-adjusting element 132, but not limited thereto. In some embodiments, a type of liquid crystal of the liquid crystal panel 132a is not limited to the above-mentioned and may be adjusted depending on needs. Since rest of the structures of the switching unit 12c of this embodiment may be identical to the switching unit 12b in FIG. 5, please refer to the above contents, and no further elaboration will be mentioned herein.

In summary, in the electronic device of the present disclosure, the panel with VA liquid crystal, ECB liquid crystal, or cholesteric liquid crystal may be combined with the phase retardation plate and the polarizer to make the pixels in the pattern mode and the pixels in the transmission mode have less than 15% difference in transmittance. Hence, the user is hard to see the pattern displayed by the switching unit, lowering the visual discomfort of the user. Besides, by using the VA liquid crystal and the ECB liquid crystal in different orientations having different reflectances to different wavelengths of light, or by using the cholesteric liquid crystal in the planar state capable of reflecting a certain wavelength band of light, the switching unit may display the color pattern, which further enhances the aesthetic of the electronic device.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a switching unit having a plurality of pixels, and the switching unit comprising:
a panel;
a phase retardation plate; and
a polarizer, wherein the phase retardation plate is disposed between the panel and the polarizer,
wherein each of the plurality of pixels has a pattern mode and a transmission mode, at least a part of the plurality of pixels in the pattern mode has a first transmittance, and at least another part of the plurality of pixels in the transmission mode has a second transmittance, and a difference between the first transmittance and the second transmittance is less than 15%.

2. The electronic device according to claim 1, wherein the switching unit has a first side and a second side opposite to the first side, wherein the first side is closer to a user than the second side, and the switching unit displays a pattern on the second side when the at least a part of the plurality of pixels is in the pattern mode.

3. The electronic device according to claim 2, wherein the pattern is a color pattern.

4. The electronic device according to claim 2, wherein the pattern is invisible to the user.

5. The electronic device according to claim 2, wherein a reflectance of the second side of the switching unit corresponding to the at least a part of the plurality of the pixels in the pattern mode is greater than a reflectance of the second side of the switching unit corresponding to the at least another part of the plurality of pixels in the transmission mode.

6. The electronic device according to claim 1, wherein the pattern mode of the at least a part of the plurality of pixels and the transmission mode of the at least another part of the plurality of pixels are performed at a same time.

7. The electronic device according to claim 1, wherein the panel comprises cholesteric liquid crystal, the cholesteric liquid crystal in the pattern mode is in a planar state, and the cholesteric liquid crystal in the transmission mode is in a homeotropic state or a focal-conic state.

8. The electronic device according to claim 7, wherein the polarizer is closer to a user than the panel, and the panel displays a pattern on a surface of the panel opposite to the phase retardation plate when the at least a part of the plurality of pixels is in the pattern mode.

9. The electronic device according to claim 7, wherein the switching unit further comprises a light-adjusting element, and the polarizer is disposed between the phase retardation plate and the light-adjusting element.

10. The electronic device according to claim 9, wherein the light-adjusting element comprises a liquid crystal panel and another polarizer, and the liquid crystal panel is disposed between the polarizer and the another polarizer.

11. The electronic device according to claim 7, wherein a transmittance of the switching unit is in the range of 30% to 50%, and a reflectance of the switching unit is in the range of 20% to 50%.

12. The electronic device according to claim 1, wherein the switching unit further comprises a transflective element, and wherein the panel is disposed between the transflective element and the phase retardation plate.

13. The electronic device according to claim 12, wherein the transflective element comprises a metal film covering an entire surface of the panel facing the transflective element.

14. The electronic device according to claim 12, wherein the transflective element comprises a reflection region and a transmission region, and the transflective element comprises a transparent film and a reflection layer, wherein the reflection layer is disposed on the transparent film in the reflection region and is not disposed in the transmission region.

15. The electronic device according to claim 1, wherein the switching unit comprises an anti-reflecting film, and the panel is disposed between the phase retardation plate and the anti-reflecting film.

16. The electronic device according to claim 1, wherein the panel comprises vertical alignment liquid crystal or electrically controlled birefringence type liquid crystal.

17. The electronic device according to claim 16, wherein the first transmittance is in a range of 1% to 40%, and a reflectance of the switching unit is in a range of 1% to 40%.

18. The electronic device according to claim 1, wherein the panel comprises a first substrate, a second substrate, a liquid crystal layer, a plurality of first electrodes, and a plurality of second electrodes, wherein the first substrate and the second substrate are disposed opposite to each other, the liquid crystal layer is disposed between the first substrate and the second substrate, the plurality of first electrodes are disposed between the first substrate and the liquid crystal layer, and the plurality of second electrodes are disposed between the second substrate and the liquid crystal layer.

19. The electronic device according to claim 1, wherein the panel comprises a plurality of subpanels stacked in a top view direction of the electronic device.

20. The electronic device according to claim 1, wherein the electronic device is glasses.
